(19) United States
(12) Patent Application Publication
(10) Pub. No.: US 2018/0314957 A1
(43) Pub. Date: Nov. 1, 2018

(54) INFERRING A LABEL NAMESPACE

(71) Applicant: Hewlett Packard Enterprise Development LP, Houston, TX (US)

(72) Inventors: Joon Myung Kang, Palo Alto, CA (US); Kshiteej S. Mahajan, Palo Alto, CA (US); Sujata Banerjee, Palo Alto, CA (US)

(21) Appl. No.: 15/582,195

(22) Filed: Apr. 28, 2017

(51) Int. Cl. G06N 5/04; H04L 12/911; G06F 17/30

(52) U.S. Cl. CPC G06N 5/04; H04L 47/82; H04L 67/10; G06F 17/30377; G06F 17/30958

(57) ABSTRACT

Example method includes: negotiating, by a network device, a location of a data source for a particular network infrastructure manager; inferring, by the network device, a meta label namespace by analyzing the data source, wherein the meta label namespaces comprises at least a relationship between a plurality of meta labels; inferring, by the network device, a label namespace that is specific to the particular network infrastructure manager from the meta label namespace; converting, by the network device, the label namespace to an abstract label namespace; and aggregating, by the network device, the abstract label namespace into a global label namespace that is applicable across diverse network infrastructures.

### BACKGROUND

Policy-driven management of cloud, IT, and/or network infrastructure often uses logical labels, tags, or metadata to define a group of policy target entities upon which network policies can be applied. Writing policies using labels in a label namespace allows the network policies to be kept at a high-level, reusable and portable. Modern enterprise deployments can be complex, e.g., spanning from on premise private data centers to public cloud deployments. These data plane deployments may be managed via a mix of multiple control plane interfaces, such as, Lightweight Directory Access Protocol (LDAP) for legacy on premise devices, Software Defined Network (SDN) for on premise infrastructure services or NFV deployments, Azure or AWS for public cloud deployments, etc. Tracking the entities across these deployments and managing the network policies spanning across these multiple control planes on a case-by-case basis can be difficult.

### BRIEF DESCRIPTION OF THE DRAWINGS

The following detailed description references the drawings, wherein:

FIG. 1 is a block diagram of an example computing architecture for inferring a label namespace;

FIG. 2 is a block diagram of an example workflow for inferring a label namespace;

FIG. 3 is a block diagram illustrating an example meta label namespace with metadata analysis;

FIG. 4 is a block diagram illustrating an example label namespace with metadata analysis;

FIG. 5 is a block diagram illustrating an example source code static analysis for inferring a label namespace;

FIG. 6 is a block diagram illustrating an example of inferring meta label namespace via static analysis of source code;

FIG. 7 is a block diagram illustrating an example of inferring label namespace via static analysis of source code;

FIG. 8 is a flowchart of an example process of inferring a label namespace; and

FIG. 9 is a block diagram of an example network device to infer a label namespace.

### DETAILED DESCRIPTION

Examples described herein include a method for inferring a label namespace. Existing policy stacks allows policy writers to utilize an intent-based policy framework to define network policies. The intent-based policy framework exposes a well-formed grammar to specify policies using high-level logical labels. However, this intent-based policy framework assumes a label namespace, which serves as the lexicon for the grammar. This label namespace often is manually created by the infrastructure administrator, which makes it static and hard to scale up.

The method and system described herein can automatically extract entity attribute information from various control planes, e.g., cloud infrastructure, an IT infrastructure, a Network Function Virtualization (NFV) infrastructure, in the form of an abstract representation, namely a Directed Acyclic Graph (DAG) of logical labels. This abstract representation comprises the logical labels corresponding to actual entity attributes spanning the enterprise deployment, and also captures relationships between the labels. Also, the system can detect any changes of entity attributes (or entity-to-label mappings) and update the abstract representation accordingly. This abstract representation can be used to solve issues of policy management, deployment agility, and deployment migration.

In particular, a new layer (hereinafter referred to as Lexicon) is introduced in the policy stack that can automatically and dynamically infer the label namespace. Lexicon can automate the construction of the label namespace used by the intent-based policy framework.

In examples described herein, a network device on which Lexicon resides, can negotiate a location of a data source for a particular network infrastructure manager. Then, the network device can infer a meta label namespace by analyzing the data source, wherein the meta label namespaces comprises at least a relationship between a plurality of meta labels. Also, the network device can infer a label namespace that is specific to the particular network infrastructure manager from the meta label namespace. Next, the network device can convert the label namespace to an abstract label namespace. Moreover, the network device can aggregate the abstract label namespace into a global label namespace that is applicable across diverse network infrastructures.

As used herein, an endpoint (EP) generally refers to a smallest unit for policy enforcement (e.g., a virtual machine, a container, a network port, a device, etc.). Endpoint (EP) is used interchangeably with the term Entity in this disclosure.

As used herein, a label generally refers to a membership predicate, a Boolean valued function representing an entity attribute (e.g., an owner, a network name, a placement location, a security status, etc.). An attribute can be either static (e.g., VM ownership) or dynamic (e.g., security status, VM location).

As used herein, an endpoint group (EPG) generally refers to a set of EPs that satisfy a membership predicate (e.g., a Boolean expression) defined over the labels. For example, an EPG defined as “Tenant: Lee & Location: Zone-1 & Security: Normal” may mean a set of virtual machines owned by Tenant “Lee,” placed in zone-1, and with Normal security status in case that the EP is VM. EPG may be used interchangeably with Entity Group (EG) in this disclosure.

Lexicon Architecture

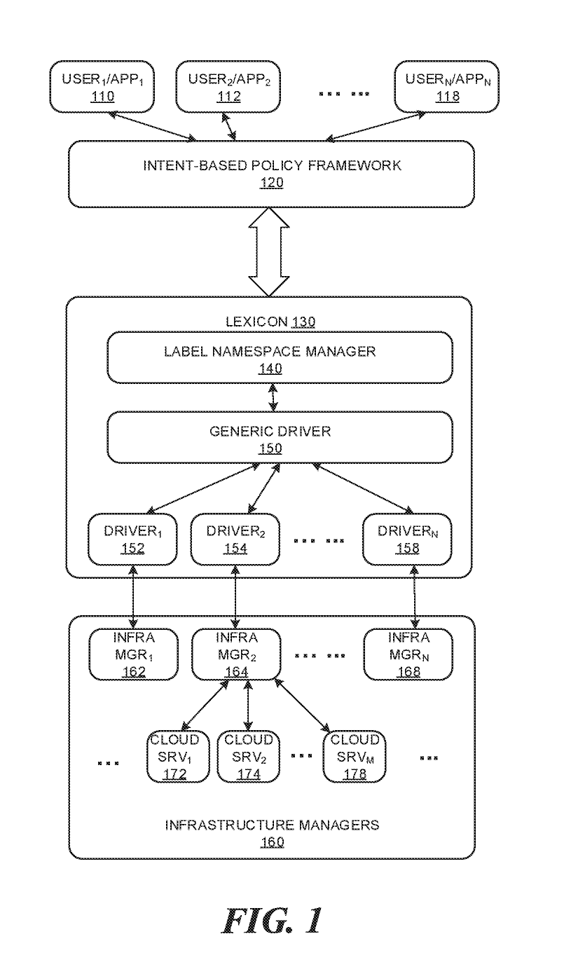

FIG. 1 is a block diagram of an example computing architecture for inferring a label namespace. FIG. 1 includes a plurality of users and/or application, such as, users/applications 110, user₂/application₂ 112, . . . , user_{N}/application_{N} 118. The plurality of applications can be deployed in the network on any physical, virtual, or cloud infrastructures, including but not limited to, a cloud infrastructure, an IT infrastructure, a NFV infrastructure, etc.

Applications and users 112-118 may interact with an intent-based policy framework 120. Intent-based policy framework 120 generally can expose label namespace inferred by lexicon 130 to policy writers, such that policy writers can use the labels in the label namespace to define network policies.

Lexicon 130 generally refers to a component that interfaces intent-based policy framework 120 and also interfaces with infrastructure managers 160. Lexicon 130 includes a label namespace manager 140, a generic driver 150 from which a plurality of infrastructure-controller specific drivers (such as, drive₁ 152, driver₂ 154, . . . driver_{N} 158) are derived. Each driver is purpose-built for a specific infrastructure manager (e.g., InfraMgr₁ 162, InfraMgr₂ 164, . . . InfraMgr_{N} 168).

Infrastructure managers 160 includes a plurality of diverse infrastructure managers (e.g., InfraMsgr₁ 162, InfraMgr₂ 164, . . . InfraMgr_{N} 168), including but not limited to, a cloud infrastructure manager for managing cloud-based services, a NFV infrastructure manager for managing virtual network functions, an IT infrastructure manager for managing various IT services, etc. Each infrastructure manager 162-168 may manage several services. For example, InfraMgr₂ 164 may be a cloud infrastructure manager that manages a plurality of cloud services, such as, CloudSrv₁ 172, CloudSrv₂ 174, . . . , CloudSrv_{M} 178. Also, each driver 152-158 infers a label namespace for its corresponding infrastructure manager 162-168. The label namespaces inferred by the drivers 152-158 are collectively managed by label namespace manager 140. Label namespace manager 140 can further expose the aggregated and type-annotated label namespace to intent-based policy framework 120. Several users or applications 110-118 can then use the inferred label namespace to write policies independently.

Lexicon architecture provides several features.

(1) Automation & Scalability: Drivers 152-158 in lexicon 130 are purpose-built for each infrastructure manager. However, the driver design is derived from a generic driver 150. Each driver negotiates the data sources for the underlying infrastructure manager, and then uses purpose-built techniques to learn the label namespace automatically from the data sources. Automatic label namespace inference avoids manual curation by an administrator and ensures scalability.

(2) Dynamism: Drivers 152-158 in lexicon 130 can dynamically update the label namespace by automatically polling dynamic data sources.

(3) Modularity and extensibility: Lexicon architecture can be a plug-in system that has purpose-built drivers 152-158 per infrastructure manager 162-168. Drivers may be synthesized without making changes to the underlying infrastructure managers. Moreover, the label namespace is maintained separately from the underlying infrastructure manager. This makes the lexicon architecture extensible, because a new infrastructure manager can be added easily by the driver outputting the inferred label namespace for the underlying infrastructure in a type-annotated directed acyclic graph.

(4) Coherence: The inferred label namespace can be aggregated and not exposed to intent-based policy framework 120 in isolation. Thus, policies can be written coherently for a general class of entities even if they belong to different isolated domains. Also, this increases the policy writer's efficiency by avoiding repeated efforts.

(5) Flexibility: Lexicon 130 also leverages type-annotations in the label namespace to enable the policy writer to extend labels with derived labels. This flexibility gives the policy writer additional degrees of freedom to write even-more expressive policies.

(6) Fungibility: Label namespace manager 140 with the aid of meta-label type annotations can transfer label namespace and policies across infrastructure domains.

As used herein, meta-labels generally refer to various entity classes. For example, “Department-Name” is a class of entity that refers to departments that utilize the underlying infrastructure. Entity classes may have associated type. The type can be primitive or non-primitive. Primitive types are flexible, whereas non-primitive types are non-flexible. For example, “Department-Name” is a non-primitive type. On the other hand, “Disk-Type” is a primitive type. Instantiations of non-primitives (labels associated with non-primitive meta-labels) can be renamed. For example, label “Engineering” can be renamed to some other canonical unique name, as long as the old name is replaced by the new name in the policy set. However, the label “SSD” associated with the meta-label “Disk-Type” is inherently constant and irreplaceable.

As used herein, labels generally refer to instantiations of the entity classes associated with meta-labels. For example, “Engineering,” “Sales,” . . . , “Marketing” are actual instantiations of the entity class of “Department-Name.” Each label may have an associated type. In this example, each of the label is of type “String.”

As used here, label relationships generally include a label hierarchy and a plurality of label mappings. The label hierarchy can be used to capture the membership of each label, which recursively includes one or multiple labels. When represented in a directed acyclic graph (DAG), the vertices represent the labels and the directed edges represent the “subsumes” relationship. Label relationship also may include label mapping that are tautologies on Boolean predicates using labels that belong to disconnected portions of the directed acyclic graph. Mappings can alternatively be added as ubiquitous polices initialized by default. Also, several relationships between labels can be derived by analyzing the structure of the directed acyclic graph. For example, two labels may be “mutually exclusive” if they do not have a common descendant label. Note that label relationships also apply to meta labels. Thus, multiple meta labels may have a meta relationship, from which a label relationship can be instantiated.

Lexicon Workflow

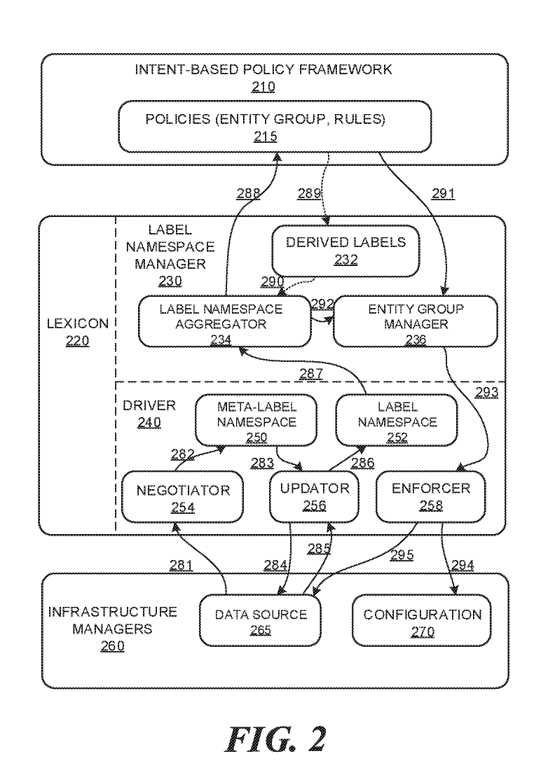

FIG. 2 is a block diagram of an example workflow for inferring a label namespace. Specifically, FIG. 2 includes lexicon 220 that interfaces with both an intent-based policy framework 210 and infrastructure managers 260. The principal layers of lexicon 220 includes label namespace manager 230 and driver 240. Each of these layers can be purpose-fitted for specific infrastructure managers for various types of infrastructures (e.g., a cloud infrastructure, an IT infrastructure, a NFV infrastructure, etc.). The workflow of lexicon 220 as illustrated in FIG. 2 can accomplish two tasks. The first task is label namespace inference, and the second task is policy specification, validation, and enforcement.

A. Label Namespace Inference

To perform label namespace inference by interacting with a generic infrastructure manager, lexicon 220 utilizes several internal components, including but not limited to, a negotiator 254, an updater 256, and a label namespace aggregator 234. Each component corresponds to a phase in label namespace inference, namely, a negotiation phase, an update phase, and an aggregation phase.

During negotiation phase, negotiator 254 can negotiate a location of data sources 265 for the underlying infrastructure manager 260 (step 281), and construct a meta-label namespace 250 (step 282). Data sources 265 may include information about infrastructure manager 260 that aids interference of the label namespace. Examples of various data sources that lexicon 220 supports may include: structured data, metadata, source code, and unstructured data.

Specifically, structured data may refer to a relational database management system (RDBMS). For example, MySQL database dump may be a data source for OpenStack SDN infrastructure. Alternatively, any kinds of database that has a structured schema may be used as a structured data source.

Metadata may be used to describe various databases. For example, in RDBMS, data definition language (DDL) is one instance of metadata source. The DDL dump of a MySQL database, as in the case of OpenStack, is a specific example of metadata.

Source code generally refers to any collection of commands that can be compiled or interpreted to execute on a computing device. An example of source code supported by lexicon 220 may be a link to a repository that points to the source code for infrastructure manager 260, e.g., github.com for OpenStack.

Unstructured data can be any how-to docs for the underlying infrastructure manager 260. For example, API documentation for OpenStack may be unstructured data supported by lexicon 220.

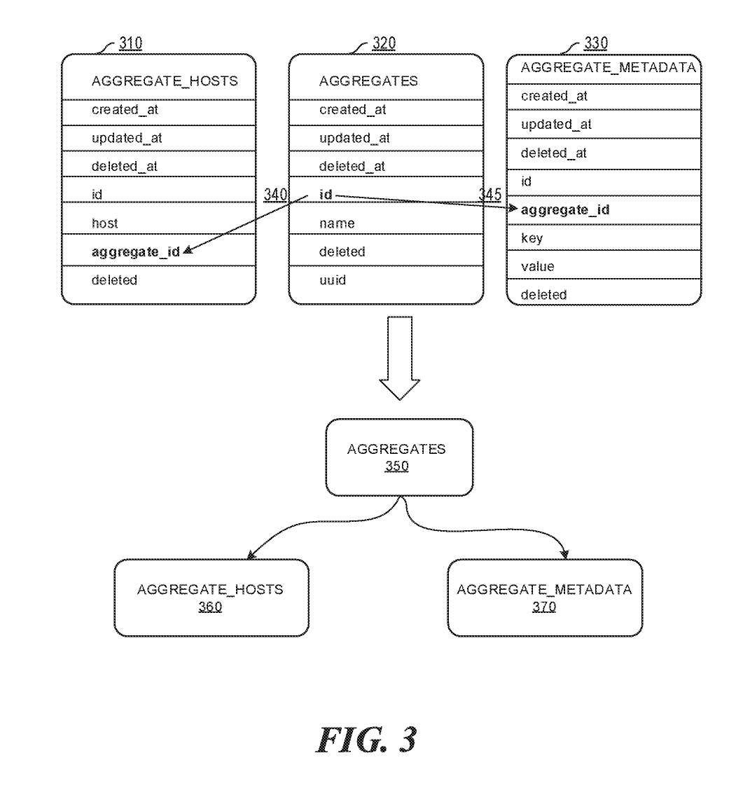

Negotiator 254 can first parse various configuration files 270 associated with the underlying infrastructure manager 260 to locate the relevant data sources 265 for label namespace inference. After negotiating the location of data sources 265, the meta-label namespace 250 can be inferred by analyzing the relevant data sources 265. Here, the meta-label namespace 250 includes a directed acyclic graph capturing relationships between meta-labels. An example of a meta-label relationship is each virtual machine “VM-ID” has a location “Availability-Zone.” In this example, the directed acyclic graph may include two vertices, namely, “Host-Name” and “Availability-Zone” meta-labels, as well as a directed edge with the source being “Availability-Zone” and the sink being “Host-Name.” A detailed example of meta-label namespace inference in the context of OpenStack is described in the section below as related to FIG. 3.

Updater 256 generally is responsible for inferring the label namespace specific to the particular infrastructure manager. During the update phase, updater 256 may take the meta-label namespace 250 as inputs (step 283), and poll the relevant data sources 265 that are initially negotiated by negotiator 254 (step 284 and 285). Based on polled data from the relevant data sources 265, updater 256 to infer label namespace 252 (step 286). Further, updater 256 can keep polling the relevant data sources 265 to keep track of any dynamic changes in label namespace 252.

Next, during the aggregation phase, label namespace aggregator 234 can receive the infrastructure-manager specific label namespace 252 (step 287), convert the infrastructure-manager specific label namespace 252 to an abstract label namespace, and then aggregate the abstract label namespace with the global label namespace maintained in lexicon 220. Conversion of label namespace to an abstract label namespace may involve renaming of non-primitive labels to avoid collision in namespace. It may also involve coalescing of label namespace to the global namespace using non-primitive type label vertices as the connection points between the existing global label namespace and the localized infrastructure manager specific label namespace.

B. Policy Specification, Validation, and Enforcement

Intent-based policy framework 210 may interact with lexicon 220's label namespace manager 230 to aid a policy writer for policy specification. In particular, the label namespace inferred by lexicon 220 is exposed to the intent-based policy framework 210 (step 288). The policy writer may use this label namespace as the lexicon to write policies 215 that adhere to the grammar as mandated by the intent-based policy framework 210. The label declarations in the existing grammar can be extended to enable derived label declarations 232 (step 289). For the case of PGA, the labels are assumed to be of “String” type, supporting equality operations. Lexicon 220 also enables support for numeric comparable labels that can be used to yield derived labels 232 by application of comparison operations.

These derived labels 232 can then be added to the aggregate label namespace 234 (step 290).

During policy validation and/or enforcement, there are two observations. First, intent-based policy framework 210 compiles user-specified policies 215 as [normalized EG, Rules] pairs. Second, normalized EGs are Boolean predicates over labels in the aggregated label namespace 234. Moreover, any changes in the label namespace may affect EG membership. In light of these two observations, the EG manager 236 for lexicon 220 maintains interactions with both intent-based policy framework 210 and aggregated label namespace 234. Specifically, EG manager 236 inputs [normalized EG, rules] pairs when there is a policy update (step 291).

Also, EG manager 236 triggers an update in the aggregated label namespace 234 when a label namespace update is detected. In addition, EG manager 236 further can trigger policy validity checks, or may trigger policy enforcement at enforcer 258 (step 293). A policy validity check may involve checking certain graph invariants on the label namespace. For example, assuming that there is a new policy stating that “Not (CPU-Utilization>90% & Tenant-Name==Lee & Application-Name==App-1)”. Because “CPU-Utilization>90%” is a derived label, the policy validity check involves checking whether the given Boolean predicate is a tautology. If the policy validation fails, then enforcer 258 may take further actions. For example, the enforcer 258 might then add an additional virtual machine to the pool of virtual machines associated with the App-1 load balancer. This action can be realized via the appropriate configuration commands 270 in the underlying infrastructure manager 260 (step 294). In other examples, the action taken by enforcer 258 may involve changing relevant data sources 265 in the underlying infrastructure manager 260 (step 295).

Structured Data Meta Analysis

FIG. 3 is a block diagram illustrating an example meta label namespace with metadata analysis. Specifically, FIG. 3 illustrates an example lexicon for OpenStack. OpenStack generally refers to a cloud operating system that can control large pools of compute, storage, and networking resources throughout a datacenter, the resources being managed through a dashboard that gives administrators control while empowering their users to provision resources through a web interface.

The negotiator of lexicon, in the example of OpenStack, can negotiate the source code location and a URL corresponding to the SQL databases connection. The negotiator may manage this by fetching the *.conf files associated with the OpenStack components (*={nova, neutron, cinder, glance, keystone, . . . }). The source code can be used for static analysis to infer meta-label namespace, whereas the SQL databases can be used by the updater for label namespace inference.

For example, the configuration file for the nova component is shown in Table 1 below.

TABLE 1
--
-- Table structure for table ′aggregate_hosts′
--
DROP TABLE IF EXISTS ′aggregate_hosts′;

| | |
|---|---|
| /*!40101 SET @saved_cs_client | = @@character_set_client |

*/;
/*!40101 SET character_set_client = utf8 */;
CREATE TABLE ′aggregate_hosts′ (

′created_at′ datetime DEFAULT NULL,
′updated_at′ datetime DEFAULT NULL,
′deleted_at′ datetime DEFAULT NULL,
′id′ int(11) NOT NULL AUTO_INCREMENT,
′host′ varchar(255) DEFAULT NULL,
′aggregate_id′ int(11) NOT NULL,
′deleted′ int(11) DEFAULT NULL,
PRIMARY KEY (′id′),
UNIQUE KEY

′uniq_aggregate_hosts0host0aggregate_id0deleted′
(′host′, ′aggregate_id′, ′deleted′),

KEY ′aggregate_id′ (′aggregate_id′),
CONSTRAINT ′aggregate_hosts_ibfk_1′ FOREIGN KEY

(′aggregate_id′) REFERENCES ′aggregates′ (′id′)
) ENGINE=InnoDB AUTO_INCREMENT=7 DEFAULT
CHARSET=utf8;
/*!40101 SET character_set_client = @saved_cs_client */;
--
-- Table structure for table ′aggregate_metadata′
--
DROP TABLE IF EXISTS ′aggregate_metadata′;

| | |
|---|---|
| /*!40101 SET @saved_cs_client | = @@character_set_client |

*/;
/*!40101 SET character_set_client = utf8 */;
CREATE TABLE ′aggregate_metadata′ (

′created_at′ datetime DEFAULT NULL,
′updated_at′ datetime DEFAULT NULL,
′deleted_at′ datetime DEFAULT NULL,
′id′ int(11) NOT NULL AUTO_INCREMENT,
′aggregate_id′ int(11) NOT NULL,
′key′ varchar(255) NOT NULL,
′value′ varchar(255) NOT NULL,
′deleted′ int(11) DEFAULT NULL,
PRIMARY KEY (′id′),
UNIQUE KEY

′uniq_aggregate_metadata0aggregate_id0key0deleted′
(′aggregate_id′, ′key′, ′deleted′),

KEY ′aggregate_metadata_key_idx′ (′key′),
CONSTRAINT ′aggregate_metadata_ibfk_1′ FOREIGN KEY

(′aggregate_id′) REFERENCES ′aggregates′ (′id′)
) ENGINE=InnoDB AUTO_INCREMENT=3 DEFAULT
CHARSET=utf8;
/*!40101 SET character_set_client = @saved_cs_client */;
--
-- Table structure for table ′aggregates′
--
DROP TABLE IF EXISTS ′aggregates′;
/*!40101 SET @saved_cs_client = @@character_set_client
*/;
/*!40101 SET character_set_client = utf8 */;
CREATE TABLE ′aggregates′ (

′created_at′ datetime DEFAULT NULL,
′updated_at′ datetime DEFAULT NULL,
′deleted_at′ datetime DEFAULT NULL,
′id′ int(11) NOT NULL AUTO_INCREMENT,
′name′ varchar(255) DEFAULT NULL,
′deleted′ int(11) DEFAULT NULL,
′uuid′ varchar(36) DEFAULT NULL,
PRIMARY KEY (′id′),
KEY ′aggregate_uuid_idx′ (′uuid′)

) ENGINE=InnoDB AUTO_INCREMENT=3 DEFAULT
CHARSET=utf8;
/*!40101 SET character_set_client = @saved_cs_client */;

Meta-Label Namespace inference can be done by analyzing the metadata obtained from the DDL dumps of the SQL database. For example, based on the above configuration file, the updater can infer a SQL database table schema as shown in FIG. 3. Specifically, this OpenStack component includes three tables, namely, aggregate_hosts 310, aggregates 320, and aggregate_metadata 330. From the configuration file, the updater can also infer that the table aggregate_hosts 310 has the following columns: created_at, updated_at, deleted_at, id, host, aggregate_id, and deleted, where id is the primary key. Also, the updater can infer that the table aggregates 320 has the following columns: created_at, updated_at, deleted_at, id, name, deleted, and uuid, where id is the primary key. Furthermore, the updater can infer that the table aggregate_metadata 330 has the following columns: created_at, updated_at, deleted_at, id, aggregate_id, key, value, and deleted, where id is the primary key. In addition, from the configuration file, the updater can determine that there is a foreign key reference 340 from id column in table aggregates 320 to aggregate_id column in the table aggregate_hosts 310. Similarly, the updater can determine that there is a second foreign key reference 345 from id column in table aggregates 320 to aggregate_id column in the table aggregate_metadata 330.

Based on the above information regarding the OpenStack SQL database table schema, the updater can generate a plurality of meta labels and the relationships between them as depicted in FIG. 3. In this example, three meta labels are generated: meta label aggregates 350 corresponds to table aggregates 320; meta label aggregate_hosts 360 corresponds to table aggregate_hosts 310, and meta label aggregate_metalabel 370 corresponds to table aggregate_metadata 330. Also, a first directed edge from meta label aggregates 350 to meta label aggregate_hosts 360 represents a meta relationship between the two meta labels, which can be inferred from the foreign key reference 340. Likewise, a second directed edge from meta label aggregates 350 to meta label aggregate_metadata 370 represents a meta relationship between the two meta labels, which can be inferred from the foreign key reference 345.

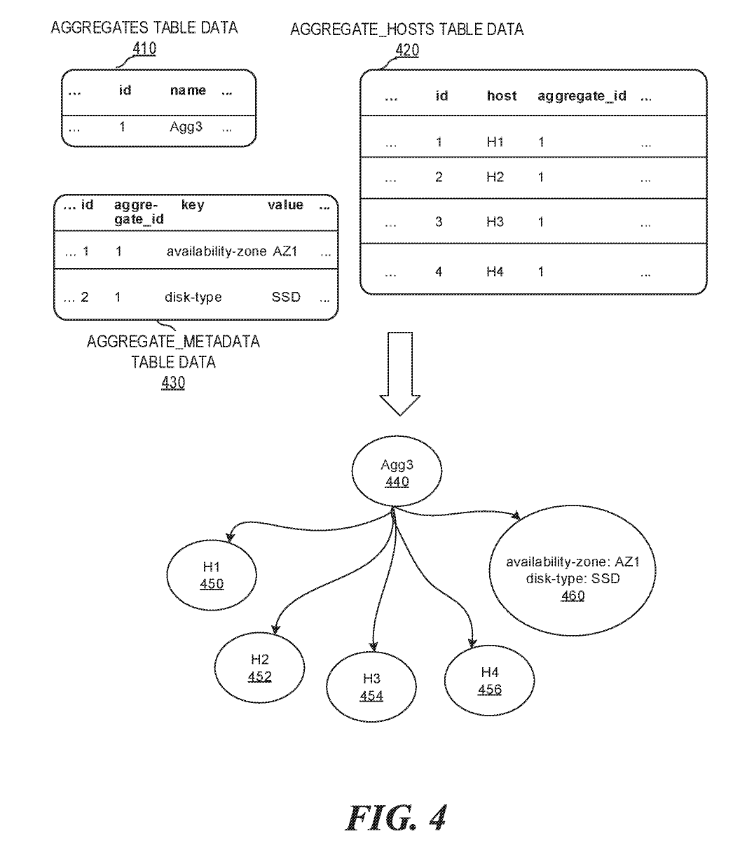

After the meta-label namespace is inferred, the updater can then create the label namespace by fetching the appropriate entries from the SQL database corresponding to the meta-labels. The meta-label namespace and the corresponding database entries are used to create the label namespace. FIG. 4 is a block diagram illustrating an example label namespace with metadata analysis.

In this example, aggregates table data 410 shows example data stored in the table aggregates 320; aggregate_hosts table data 420 shows example data stored in the table aggregate_hosts 310, and aggregate_metadata table data 430 shows example data stored in the table aggregate_metadata 330. Based on the example data in the table entries, the updater can create labels, such as, Agg3 440 (which corresponds to the aggregate entry in aggregates table data 410), H1 450, H2 452, H3 454, H4 456 (each corresponds to an host entry in aggregate_hosts table data 420), and “availability-zone: AZ1, disk-type: SSD” 460 (which corresponds to the metadata entry in aggregate_metadata table data 430), in the label namespace. Moreover, directed edges are created in the DAG from Agg3 440 to each of H1 450, H2 452, H3 454, H4 456, and “availability-zone: AZ1, disk-type: SSD” 460, which represents a relationship between the label Agg3 440 and the other labels as derived from the foreign key constraint between id in aggregates table and aggregate_id in the aggregate_hosts or the aggregate_metadata table.

In general, the updater may use the follwoing mechanism to infer the relationships between the labels in the label namespace. for table in tables:

for fk in table.foreign_keys:
if fk.reference.is_primary_key & !fk.self.is_primary_key:
   (1-many) fk.reference.table is parent of fk.self.table
else if fk.reference.is_primary_key & fk.self.is_primary_key:
   (1-1) fk.reference.table is uniquely related to fk.self.table
else if !fk.reference.is_primary_key & fk.self.is_primary_key:
   (many-1) fk.reference.table is child of fk.self.table
else if !fk.reference.is_primary_key & !fk.self.is_primary_key:
   (many-many) fk.reference.table is related to fk.self.table

Static Analysis of Source Code

OpenStack uses SQLAlchemy as an object relational mapper (ORM). Each logical entity in OpenStack can be stored as a table in a SQL database by using the SQLAlchemy python library. This involves implementing each logical entity with python class definitions that inherit from the <sqlalchemy.ext.declarative.api.DeclarativeMeta> base class. According to some examples, this domain-specific knowledge about OpenStack may be leveraged to infer the meta-label namespace via static-analysis of the complete source code.

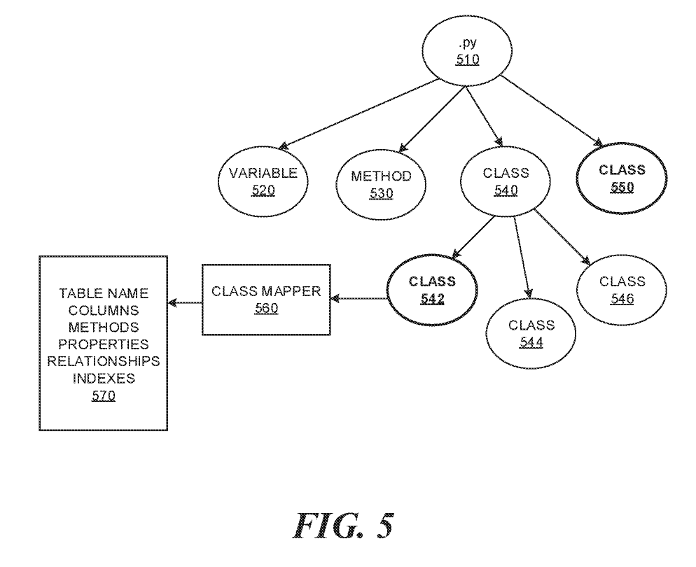

FIG. 5 is a block diagram illustrating an example source code static analysis for inferring a label namespace. In this example, the abstract syntax tree (AST) representation of each python file (e.g., .py file 510) in the source code can be analyzed to find class definitions (e.g., class 540, class 550, etc.) adhering to the aforementioned SQLAlchemy base class according to the following mechanism. for each *.py file
traverse AST to find class definitions inheriting from the given base class; entities.add make_entity class_mapper class))).

After the relevant class definitions are identified, the logical entities of OpenStack can then be decoded. Since these class (e.g., classes 542-546) definitions adhere to a specific signature where the methods (e.g., method 530) and variable (e.g., variable 520) initializations mandated by the SQLAlchemy base class (e.g., class 540) are implemented, the class mapper utility 560 of the SQLAlchemy library may be utilized to obtain an intermediate standardized form for these class definitions. After this, a self-defined make_entity function infers several constraints, mappings, and relationships this logical entity has with other logical entities. Each logical entity may directly correspond to a logical label. The “foreign_key” constraint along with the “orm.relationship” property, if any, obtained from the SQLAlchemy class_mapper 560 are used to infer a hierarchy across these logical labels. The “key” properties and the “method” definitions obtained from the class_mapper are further used to obtain label mappings across labels (e.g., table name, columns, methods, properties, relationships, indexes, etc. 570). Each “key” property is a canonical representation for the logical label that this “key” belongs to and is represented as a separate logical label.

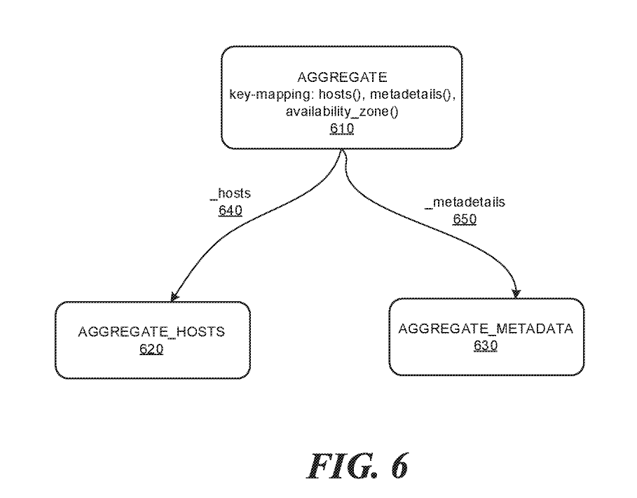

Alternatively, the source code can be statically analyzed to obtain the meta-label namespace. Thereafter, using the meta-label namespace and the corresponding database entries, the label namespace can be obtained. FIG. 6 is a block diagram illustrating an example of inferring meta label namespace via static analysis of source code. The example source code snippet is shown in Table 2 below.

TABLE 2

class AggregateHost(BASE, NovaBase,
models.SoftDeleteMixin):

″″″Represents a host that is member of an aggregate.″″″
_{——}tablename_{——} = ′aggregate_hosts′
_{——}table_args_{——} = (schema.UniqueConstraint(

″host″, ″aggregate_id″, ″deleted″,

name=″uniq_aggregate_hosts0host0aggregate_id0deleted″

),

)
id = Column(Integer, primary_key=True,

autoincrement=True)

host = Column(String(255))
aggregate_id = Column(Integer,

ForeignKey(′aggregates.id′), nullable=False)
class AggregateMetadata(BASE, NovaBase,
models.SoftDeleteMixin):

″″″Represents a metadata key/value pair for an

aggregate.″″″

_{——}tablename_{——} = ′aggregate_metadata′
_{——}table_args_{——} = (

schema.UniqueConstraint(″aggregate_id″, ″key″,

″deleted″,
name=″uniq_aggregate_metadata0aggregate_id0key0deleted″

),

Index(′aggregate_metadata_key_idx′, ′key′),

)
id = Column(Integer, primary_key=True)
key = Column(String(255), nullable=False)
value = Column(String(255), nullable=False)
aggregate_id = Column(Integer,

ForeignKey(′aggregates.id′), nullable=False)
class Aggregate(BASE, NovaBase, models.SoftDeleteMixin):

″″″Represents a cluster of hosts that exists in this

zone.″″″

_{——}tablename_{——} = ′aggregates′
_{——}table_args_{——} = (Index(′aggregate_uuid_idx′, ′uuid′),)
id = Column(Integer, primary_key=True,

autoincrement=True)

uuid = Column(String(36))
name = Column(String(255))
_hosts = orm.relationship(AggregateHost,

primaryjoin=′and_(′
′Aggregate.id ==

AggregateHost.aggregate_id,′

′AggregateHost.deleted == 0,′
′Aggregate.deleted == 0)′)

_metadata = orm.relationship(AggregateMetadata,

primaryjoin=′and_(′
′Aggregate.id ==

AggregateMetadata.aggregate_id,′

′AggregateMetadata.deleted ==

0,′

′Aggregate.deleted == 0)′)

@property
def _extra_keys(self):

return [′hosts′, ′metadetails′,

′availability_zone′]

@property
def hosts(self):

return [h.host for h in self._hosts]

@property
def metadetails(self):

return {m.key: m.value for m in self._metadata}

@property
def availability_zone(self):

if ′availability_zone′ not in self.metadetails:

return None

return self.metadetails[′availability_zone′]

Using the aforementioned mechanism, the updater can infer a meta label namespace as shown in FIG. 6. This meta label namespace not only includes the classes defined in the source code snippet, e.g., aggregate 610, aggregate_hosts 620, aggregate_metadata 630, but also includes additional key properties, such as, hosts 640 and metadetails 650, as well as additional methods, such as, key-mapping: hosts ( ), metadetails ( ), availability-zone ( ). Note that these key properties and methods cannot be inferred based on DDL of the SQL database alone. Thus, the updater uses the class_mapper utility of the object relational mapper (ORM) to perform the static analysis of the source code library in order to obtain these additional information in the label namespace.

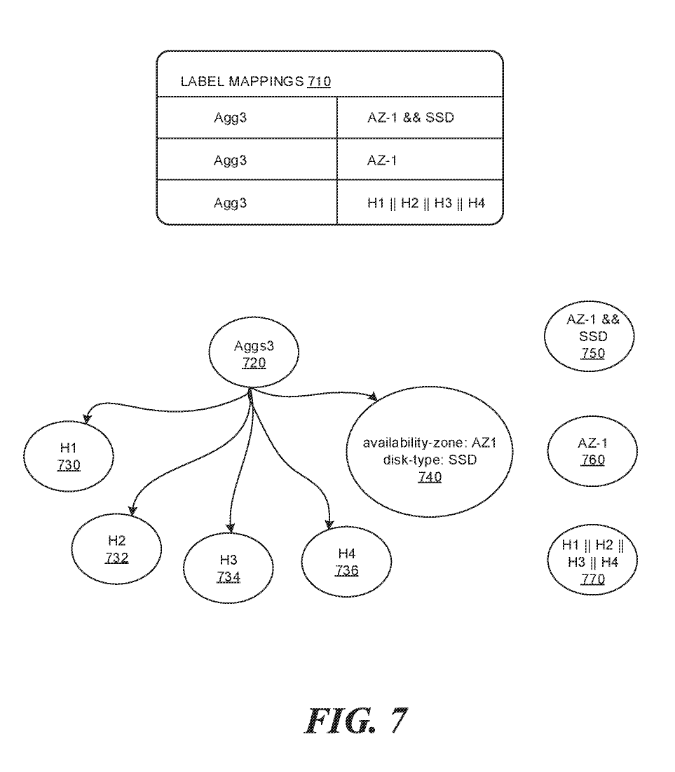

FIG. 7 is a block diagram illustrating an example of inferring label namespace via static analysis of source code. Similar to FIG. 4, based on the example source code library function call argument values, the updater can create labels, such as, Agg3 720, H1 730, H2 732, H3 734, H4 736, and “availability-zone: AZ1, disk-type: SSD” 740 in the label namespace. Moreover, directed edges are created in the DAG from Agg3 740 to each of H1 730, H2 732, H3 734, H4 736, and “availability-zone: AZ1, disk-type: SSD” 740. Additionally, in this example, the static analysis of the library source code allows updater to generate label mapping 710, which includes mappings between Agg3 and other labels, such as, AZ-1 && SSD, AZ-1, H1∥H2∥H3∥H3. These other labels are derived by examining the arguments to the library function calls. As such, additional labels (e.g., AZ-1 && SSD 750, AZ-1 760, H1∥H2∥H3∥H4 770) are created in the label namespace.

Finally, to enforce the policies, the lexicon's enforcer may enable automation by compiling the given policies and label namespace to underlying configuration for a particular infrastructure manager. The compiler for the enforcer may be synthesized for the particular infrastructure manager. In an example, the configuration application programming interface (API) for each infrastructure manager includes a pre-defined set of API commands. Each API command can accept several inputs. The lexicon can employ standard symbolic execution techniques to determine reachability of the inputs associated with each API command to various relevant points in the source code. The results can be captured via conditional predicates on the generic symbolic inputs provided to each API command.

The relevant source code points are the ones that influenced the inference of label namespace. As mentioned earlier, static analysis of source code is a generic technique used to infer the label namespace in lexicon for each infrastructure manager. The correspondences between the source code attributes and appropriate points in the label namespace can be utilized to obtain the conditional predicates on the correspondence between the API commands and the label namespace, which aids composition of the conditional attributes via symbolic execution and static analysis. Given the label namespace, the lexicon can infer the appropriate configuration by looking for a satisfying assignment for the symbolic inputs, such that the conditional predicates equalize to the actual values contained in the label namespace. This correspondence based inference can be performed in an iterative manner by traversing the label namespace in a bottom-up approach. The output configuration script may be generated by solving the satisfiability for the bottom-most layer of the label namespace, followed by the layer above, until all the vertices associated with the directed acyclic graph for the given label namespace are visited.

Processes of Inferring a Label Namespace

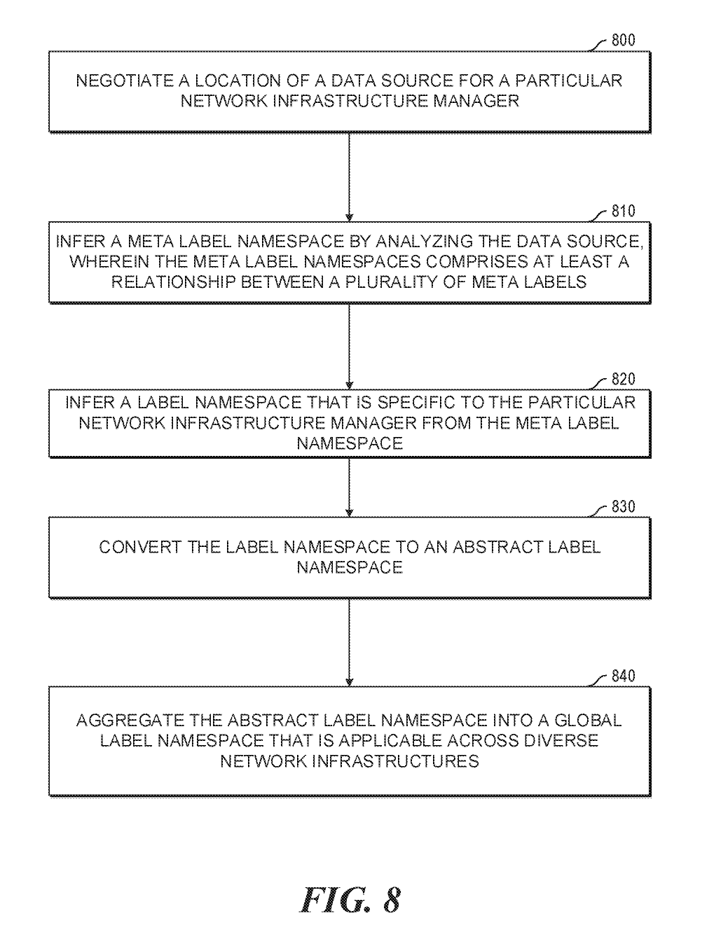

FIG. 8 is a flowchart of an example method (e.g., process) of inferring a label namespace. During operations, a network device (e.g., a lexicon) can negotiate a location of a data source for a particular network infrastructure manager (operation 800). Then, the network device can infer a meta label namespace by analyzing the data source, wherein the meta label namespaces comprises at least a relationship between a plurality of meta labels (operation 810). Next, the network device can infer a label namespace that is specific to the particular network infrastructure manager from the meta label namespace (operation 820). Thereafter, the network device can convert the label namespace to an abstract label namespace (operation 830). Moreover, the network device can aggregate the abstract label namespace into a global label namespace that is applicable across diverse network infrastructures.

In some examples, the data source may include structured data, metadata, source code, unstructured data, etc. The meta label namespace may include a directed acyclic graph (DAG) having at least two vertices and a directed edge, each vertex corresponding to a meta label and each directed edge corresponding to the relationship between the plurality of meta labels.

In some examples, the network device can infer the label namespace by analyzing constraints in the meta label namespace, and poll the data source to update changes in the label namespace.

In some examples, the network device can convert the label namespace to the abstract label namespace by renaming non-primitive labels in the label namespace to avoid a collision in the abstract label namespace.

In some examples, while aggregating the abstract label namespace into the global label namespace, the network device may use non-primitive label vertices in a directed acyclic graph as connecting points between the global label namespace and the abstract label namespace that is specific to the particular network infrastructure manager.

In some examples, the network device also may provide the global label namespace to an intent-based network policy framework. Then, the network device can receive a plurality of network policies that are written using labels in the global label namespace and rules specified in the intent-based network policy framework. In response to detecting a change in the plurality of network policies or in the global label namespace, the network device can trigger a policy validity check that checks graph invariants on the global label namespace.

Network Device to Infer a Label Namespace

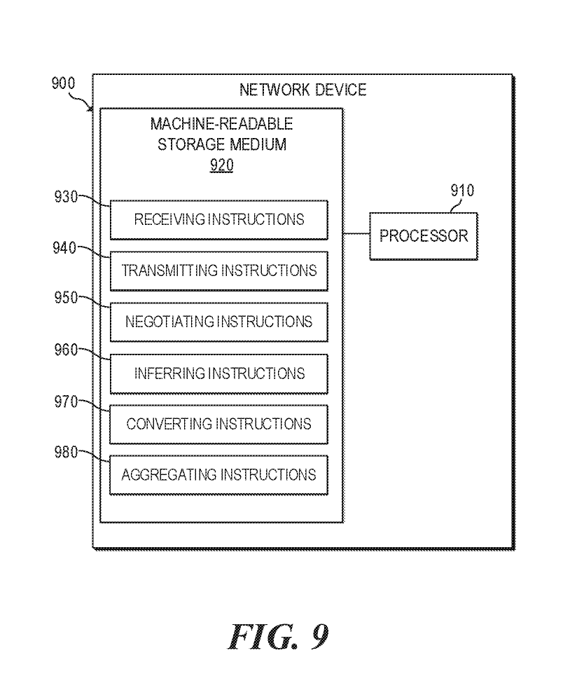

FIG. 9 is a block diagram of an example network device to infer a label namespace. As used herein, the network device may be implemented, at least in part, by a combination of hardware and programming. For example, the hardware may comprise at least one processor (e.g., processor 910) and the programming may comprise instructions, executable by the processor(s), stored on at least one machine-readable storage medium (e.g., 920). In addition, a network device may also include embedded memory and a software that can be executed in a host system and serve as a driver of the embedded memory. As used herein, a “processor” may be at least one of a central processing unit (CPU), a semiconductor-based microprocessor, a graphics processing unit (GPU), a field-programmable gate array (FPGA) configured to retrieve and execute instructions, other electronic circuitry suitable for the retrieval and execution instructions stored on a machine-readable storage medium, or a combination thereof.

The at least one processor 910 may fetch, decode, and execute instructions stored on storage medium 920 to perform the functionalities described below in relation to instructions 930-980. In other examples, the functionalities of any of the instructions of storage medium 920 may be implemented in the form of electronic circuitry, in the form of executable instructions encoded on a machine-readable storage medium, or a combination thereof. The storage medium may be located either in the computing device executing the machine-readable instructions, or remote from but accessible to the computing device (e.g., via a computer network) for execution. In the example of FIG. 9, storage medium 920 may be implemented by one machine-readable storage medium, or multiple machine-readable storage media.

Although network device 900 includes at least one processor 910 and machine-readable storage medium 920, it may also include other suitable components, such as additional processing component(s) (e.g., processor(s), ASIC(s), etc.), storage (e.g., storage drive(s), etc.), or a combination thereof.

As used herein, a “machine-readable storage medium” may be any electronic, magnetic, optical, or other physical storage apparatus to contain or store information such as executable instructions, data, and the like. For example, any machine-readable storage medium described herein may be any of Random Access Memory (RAM), volatile memory, non-volatile memory, flash memory, a storage drive (e.g., a hard drive), a solid state drive, any type of storage disc (e.g., a compact disc, a DVD, etc.), and the like, or a combination thereof. Further, any machine-readable storage medium described herein may be non-transitory. In examples described herein, a machine-readable storage medium or media may be part of an article (or article of manufacture). An article or article of manufacture may refer to any manufactured single component or multiple components.

Specifically, instructions 930-980 may be executed by processor 910 to: negotiate a location of a data source for a particular network infrastructure manager; infer a meta label namespace by analyzing the data source, wherein the meta label namespaces comprises at least a relationship between a plurality of meta labels; infer a label namespace that is specific to the particular network infrastructure manager from the meta label namespace; convert the label namespace to an abstract label namespace; aggregate the abstract label namespace into a global label namespace that is applicable across diverse network infrastructures; infer the label namespace by analyzing constraints in the meta label namespace; poll the data source to update changes in the label namespace; rename non-primitive labels in the label namespace to avoid a collision in the abstract label namespace; use non-primitive label vertices in a directed acyclic graph as connecting points between the global label namespace and the abstract label namespace that is specific to the particular network infrastructure manager; provide the global label namespace to an intent-based network policy framework; receive a plurality of network policies that are written using labels in the global label namespace and rules specified in the intent-based network policy framework; trigger a policy validity check that checks graph invariants on the global label namespace in response to detecting a change in the plurality of network policies or in the global label namespace; etc.

We claim:

1. A method comprising:
negotiating, by a network device, a location of a data source for a particular network infrastructure manager;
inferring, by the network device, a meta label namespace by analyzing the data source, wherein the meta label namespaces comprises at least a relationship between a plurality of meta labels;
inferring, by the network device, a label namespace that is specific to the particular network infrastructure manager from the meta label namespace;
converting, by the network device, the label namespace to an abstract label namespace; and
aggregating, by the network device, the abstract label namespace into a global label namespace that is applicable across diverse network infrastructures.

2. The method of claim 1, wherein the data source comprises at least one of structured data, metadata, source code, and unstructured data.

3. The method of claim 1, wherein the meta label namespace comprises a directed acyclic graph having at least two vertices and a directed edge, each vertex corresponding to a meta label and each directed edge corresponding to the relationship between the plurality of meta labels.

4. The method of claim 1, further comprising:
inferring the label namespace by analyzing constraints in the meta label namespace;
polling the data source to update changes in the label namespace.

5. The method of claim 1, wherein converting the label namespace to the abstract label namespace further comprises:
renaming non-primitive labels in the label namespace to avoid a collision in the abstract label namespace.

6. The method of claim 1, wherein aggregating the abstract label namespace into the global label namespace further comprising:
using non-primitive label vertices in a directed acyclic graph as connecting points between the global label namespace and the abstract label namespace that is specific to the particular network infrastructure manager.

7. The method of claim 1, further comprising:
providing the global label namespace to an intent-based network policy framework;
receiving a plurality of network policies that are written using labels in the global label namespace and rules specified in the intent-based network policy framework;
in response to detecting a change in the plurality of network policies or in the global label namespace, triggering a policy validity check that checks graph invariants on the global label namespace.

8. A network device in a network comprising at least:
a memory;
a processor executing instructions stored in the memory to:
negotiate a location of a data source for a particular network infrastructure manager;
infer a meta label namespace by analyzing the data source, wherein the meta label namespaces comprises at least a relationship between a plurality of meta labels;
infer a label namespace that is specific to the particular network infrastructure manager from the meta label namespace;
convert the label namespace to an abstract label namespace; and
aggregate the abstract label namespace into a global label namespace that is applicable across diverse network infrastructures.

9. The network device of claim 8, wherein the data source comprises at least one of structured data, metadata, source code, and unstructured data.

10. The network device of claim 8, wherein the meta label namespace comprises a directed acyclic graph having at least two vertices and a directed edge, each vertex corresponding to a meta label and each directed edge corresponding to the relationship between the plurality of meta labels.

11. The network device of claim 8, wherein the processor executing the instructions stored in the memory further to:
infer the label namespace by analyzing constraints in the meta label namespace; and
poll the data source to update changes in the label namespace.

12. The network device of claim 8, wherein the processor executing the instructions stored in the memory further to:
rename non-primitive labels in the label namespace to avoid a collision in the abstract label namespace.

13. The network device of claim 8, wherein the processor executing the instructions stored in the memory further to:
use non-primitive label vertices in a directed acyclic graph as connecting points between the global label namespace and the abstract label namespace that is specific to the particular network infrastructure manager.

14. The network device of claim 8, wherein the processor executing the instructions stored in the memory further to:
provide the global label namespace to an intent-based network policy framework;
receive a plurality of network policies that are written using labels in the global label namespace and rules specified in the intent-based network policy framework; and
in response to detecting a change in the plurality of network policies or in the global label namespace, trigger a policy validity check that checks graph invariants on the global label namespace.

15. A non-transitory machine-readable storage medium encoded with instructions executable by at least one processor of a network device, the machine-readable storage medium comprising instructions to:
negotiate a location of a data source for a particular network infrastructure manager;
infer a meta label namespace by analyzing the data source, wherein the meta label namespaces comprises at least a relationship between a plurality of meta labels;
infer a label namespace that is specific to the particular network infrastructure manager from the meta label namespace;
convert the label namespace to an abstract label namespace;
aggregate the abstract label namespace into a global label namespace that is applicable across diverse network infrastructures;
provide the global label namespace to an intent-based network policy framework;
receive a plurality of network policies that are written using labels in the global label namespace and rules specified in the intent-based network policy framework; and
in response to detecting a change in the plurality of network policies or in the global label namespace, trigger a policy validity check that checks graph invariants on the global label namespace.

16. The non-transitory machine-readable storage medium of claim 15, wherein the data source comprises at least one of structured data, metadata, source code, and unstructured data.

17. The non-transitory machine-readable storage medium of claim 15, wherein the meta label namespace comprises a directed acyclic graph having at least two vertices and a directed edge, each vertex corresponding to a meta label and each directed edge corresponding to the relationship between the plurality of meta labels.

18. The non-transitory machine-readable storage medium of claim 15, wherein the machine-readable storage medium further comprising instructions to:
infer the label namespace by analyzing constraints in the meta label namespace; and
poll the data source to update changes in the label namespace.

19. The non-transitory machine-readable storage medium of claim 15, wherein the machine-readable storage medium comprising instructions to:
rename non-primitive labels in the label namespace to avoid a collision in the abstract label namespace.

20. The non-transitory machine-readable storage medium of claim 15, wherein the machine-readable storage medium comprising instructions to:
use non-primitive label vertices in a directed acyclic graph as connecting points between the global label namespace and the abstract label namespace that is specific to the particular network infrastructure manager.
